(19) United States
(12) Patent Application Publication
(10) Pub. No.: US 2015/0008723 A1
(43) Pub. Date: Jan. 8, 2015

(54) RING FOR A WHEEL AND WHEEL HAVING SUCH A RING

(71) Applicants: Joerg WURFT, Schiltach (DE); Roman MUELLER, Lahr (DE)

(72) Inventors: Joerg WURFT, Schiltach (DE); Roman MUELLER, Lahr (DE)

(73) Assignee: BBS GMBH, SCHILTACH (DE)

(21) Appl. No.: 14/313,091

(22) Filed: Jun. 24, 2014

(30) Foreign Application Priority Data
Jul. 8, 2013 (DE) 10 2013 213 356.1

(51) Int. Cl. B60B 7/06; B60B 7/01

(52) U.S. Cl. CPC B60B 7/063; B60B 7/01
USPC 301/37.24

(57) ABSTRACT

The invention relates to a ring for a wheel rim of a wheel, particularly for motor vehicles, wherein the wheel rim has a rim inner well that merges into a rim inner flange, which, when the wheel is mounted, faces the motor vehicle, and a rim outer well which merges into a rim outer flange, so that the wheel rim has an uninterrupted contoured section on the axially inner side. The ring has a well lip, which extends up to the rim inner well or is designed to at least partially overlap the rim inner well. Ring has a flange lip, which faces away from the lip and is modeled on the shape of the radial inner surface of the rim inner flange. Ring provides or enables at least a partially double-walled in a hollow chamber region between the well lip and the flange lip.

### CROSS REFERENCE TO RELATED INVENTIONS

This application relates to and claims priority from German Ser. No. DE 10 2013 213 356.1 filed Jul. 8, 2013, the entire contents of which are incorporated herein by reference.

### FIGURE SELECTED FOR PUBLICATION

FIG. 3

### BACKGROUND OF THE INVENTION

1. Field of the Invention

The invention relates to a ring for a wheel, in particular for a wheel rim of an alloy wheel for motor vehicles, and to a wheel having such a ring.

2. Description of the Related Art

Wheel rims of known wheels have a rim inner well and a rim outer well. When the wheel is mounted on a motor vehicle, the rim inner well is disposed facing the motor vehicle and merges into a rim inner flange. The opposing rim outer well merges into a rim outer flange. The wheel rim has at least one uninterrupted or circumferential contoured section on the axially inner side.

It is further known to support a ring on the radially inner side or the radially outer side against a contoured section of the wheel rim. WO 2001/17799 A1, the entire contents of which are incorporated herein by reference, proposes providing half shells in the region of the rim inner well and/or the rim outer well and connecting said half shells to one another and to the adjoining elements of the wheel by means of suitable fastening methods. However, producing and assembling wheels of this design is relatively time-consuming and costly.

According to the method proposed in WO 2005/123418, the entire contents of which are incorporated herein by reference, a hollow chamber extending at least partially continuously in the peripheral direction is formed in a region of the inner side of a wheel and/or the outer side of a wheel, and is delimited by a profiled wall in a region of the rim inner well and/or rim outer well. The profiled wall is designed as integral with the rim, or a separate profiled wall is inserted into a profiled section to create a hollow chamber.

Accordingly, there is a need for an improved ring for a wheel and a wheel having such a ring that responds to one of the concerns noted.

### ASPECTS AND SUMMARY OF THE INVENTION

In response, it is now recognized that a ring for a wheel and a wheel having such a ring is provided.

The invention relates to a ring for a wheel rim of a wheel, particularly for motor vehicles, wherein the wheel rim has a rim inner well that merges into a rim inner flange, which, when the wheel is mounted, faces the motor vehicle, and a rim outer well which merges into a rim outer flange, so that the wheel rim has an uninterrupted contoured section on the axially inner side. The ring has a well lip, which extends up to the rim inner well or is designed to at least partially overlap the rim inner well. Ring has a flange lip, which faces away from the lip and is modeled on the shape of the radial inner surface of the rim inner flange. Ring provides or enables at least a partially double-walled in a hollow chamber region between the well lip and the flange lip.

One alternative aspect of the invention is to improve on wheel rims, particularly in terms of their production and/or assembly methods, their statics, and preferably in terms of their weight and in terms of the tire sounds caused by the wheel rim and/or the wheel.

Another alternative aspect is attained according to the invention by a ring having the features of the claims.

In another alternative aspect of the present invention, the ring according to the invention has a well lip, which extends up to the rim inner well. According to the invention, the well lip can also at least partially overlap the rim inner well. The ring further has a flange lip, facing away from the well lip, which flange lip is modeled on the shape of the radial inner surface of the rim inner flange. In the region of a hollow chamber between the well lip and the flange lip, the ring is embodied as at least partially double-walled or is designed such that in a mounted state, the ring forms a double wall together with the wheel rim.

According to another alternative aspect of the present invention, with a ring of this type, a wheel rim can be curved in its axially inner region. This is achieved according to the invention, without introducing any additional weight overall. Wheel rims according to the invention having a ring of this type show a decrease in weight of approximately 10% over other similarly rigid wheel rims.

According to another alternative aspect of the present invention, it is not necessary for the double-walled area in the region of the hollow chamber to be designed as a fully closed profiled section. It may be advantageous—particularly in terms of production engineering, costs and speeds, for one wall to be designed as an unattached end, so that a closed hollow chamber is not formed, but may be optionally arranged upon final assembly or not.

According to another alternative aspect of the present invention, an inner wall extends on the radially inner side and an outer wall extends on the radially outer side in the region of the hollow chamber, the two walls extending substantially parallel to one another. Between the outer wall and the inner wall, radial walls aligned in the radial direction are arranged such that a hollow chamber having a substantially rectangular cross-section is formed.

According to another alternative aspect of the present invention, bracing in the radial direction in at least two points is advantageous in terms of statics.

According to a further advantageous embodiment, the ring is embodied partially as a hollow profiled section having at least one closed hollow chamber. Multiple closed hollow chambers can be arranged side by side in the axial direction, wherein each of the multiple hollow chambers is designed as uninterrupted in the peripheral direction. Within an uninterrupted hollow chamber, an additional radial wall can likewise subdivide the uninterrupted hollow chamber into multiple peripheral hollow chambers.

According to another alternative aspect of the present invention, hollow chambers of this type can be filled with a fluid medium.

According to a further advantageous embodiment, the hollow chamber(s) can be filled with an insulating material, in particular, with a metal foam or a plastic foam, of any type know to those of skill in the art of foam.

According to another alternative aspect of the present invention, in this manner, noise damping can be achieved.

According to another alternative aspect of the present invention, and according to a further advantageous embodiment, the ring is made at least partially of aluminum and/or plastic.

A generic wheel, particularly an alloy wheel for motor vehicles, consists essentially of a wheel spider and a wheel rim, wherein the wheel rim has a rim inner well which merges into a rim inner flange on the inner side of the wheel and a rim outer well which merges into a rim outer flange on the outer side of the wheel, so that the wheel rim has an uninterrupted contoured section on the axially inner side.

According to another alternative aspect of the present invention, a wheel that is equipped with the ring according to the invention is characterized in that the safety thereof is ensured even if the ring should become detached from its connection to the wheel rim.

According to another alternative aspect of the present invention, the generic wheel can further have a hollow chamber that extends at least partially continuously in the peripheral direction in the region of the inner side of the wheel and/or the outer side of the wheel, wherein said chamber can be delimited by a profiled wall in the region of the rim inner well and/or the rim outer well. According to the invention, the hollow chamber or an additional hollow chamber is then formed in a separate ring, which can be attached to the wheel.

According to another alternative aspect of the present invention, and according to one advantageous embodiment of a wheel according to the invention, the ring is glued and/or welded into the wheel rim.

According to another alternative aspect of the present invention, for adhesive joints, a defined adhesive gap is provided, and for welded joints, a defined welding point is provided. Known adhesive systems harden during the coating process.

According to another alternative aspect of the present invention, a secure connection between ring and wheel rim is thereby ensured.

According to a further advantageous embodiment, the sole corresponding bonding surfaces are provided between the well lip and the rim inner well, and between the flange lip and the rim inner flange. The ring and the wheel rim are connected to one another solely via the corresponding bonding surfaces, so that a further hollow chamber region is formed between ring and wheel rim, outside of the hollow chamber region radially.

In the following, an alternative and adaptive embodiment example of the wheel rim according to the invention will be specified in greater detail with reference to the figures. The same reference signs will be used to identify the same parts. In the interest of clarity, the figures do not each contain all of the reference signs.

One of skill in the art will recognize that a spoke design with spoke webs extending in a Y-shape has been selected for illustrating the invention. However, according to the invention, any type of wheel spider, webs, or equivalent wheel elements may alternatively be used without departing from the scope and spirit of the present invention.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 a cross-section of a wheel according to the invention having a ring according to a first embodiment example of the invention,

FIG. 2 is a partial enlarged section of the wheel according the invention of FIG. 1.

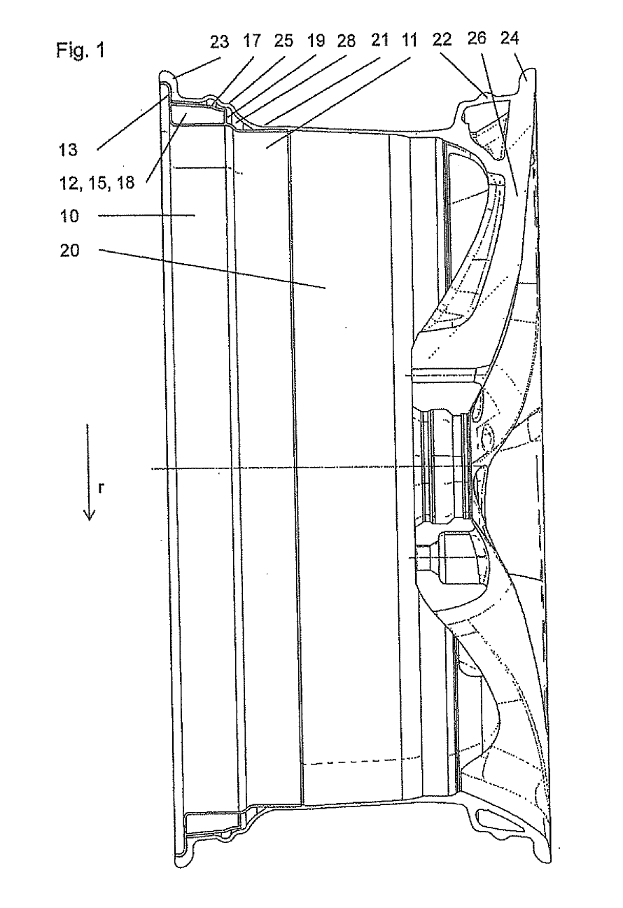

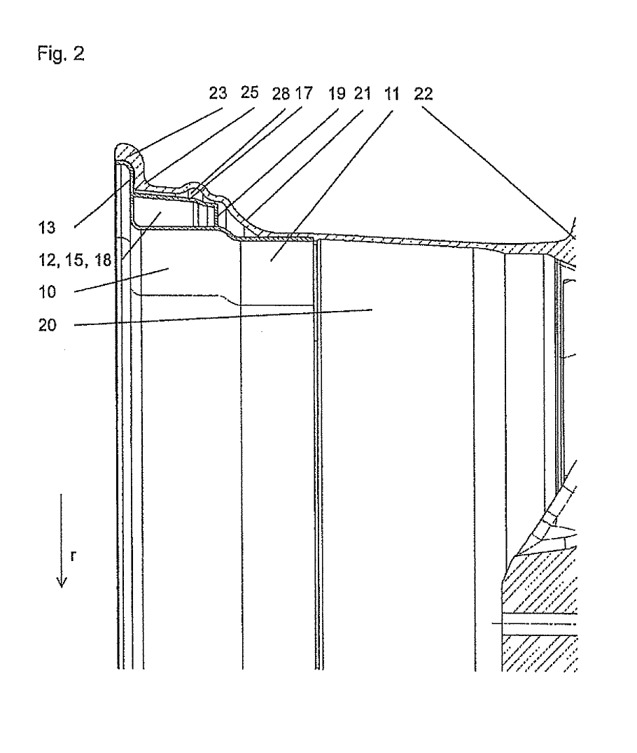

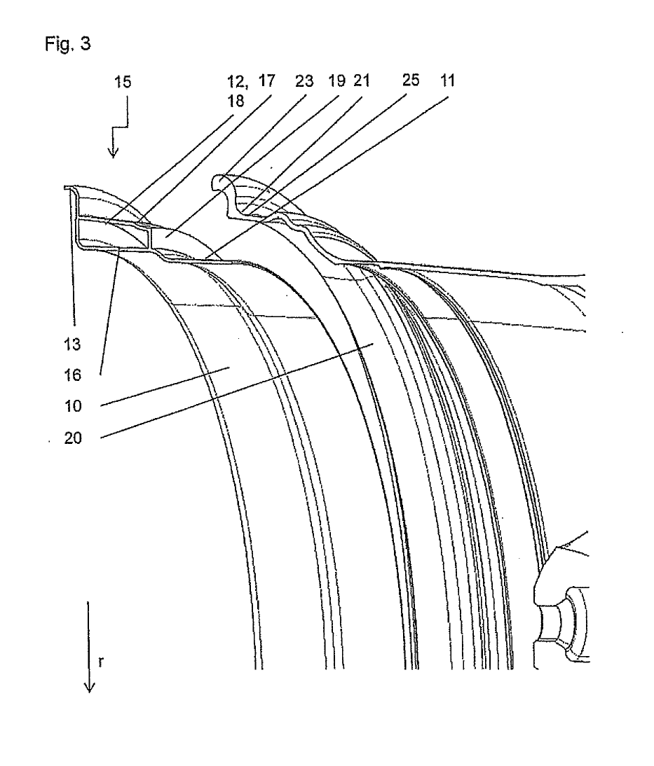

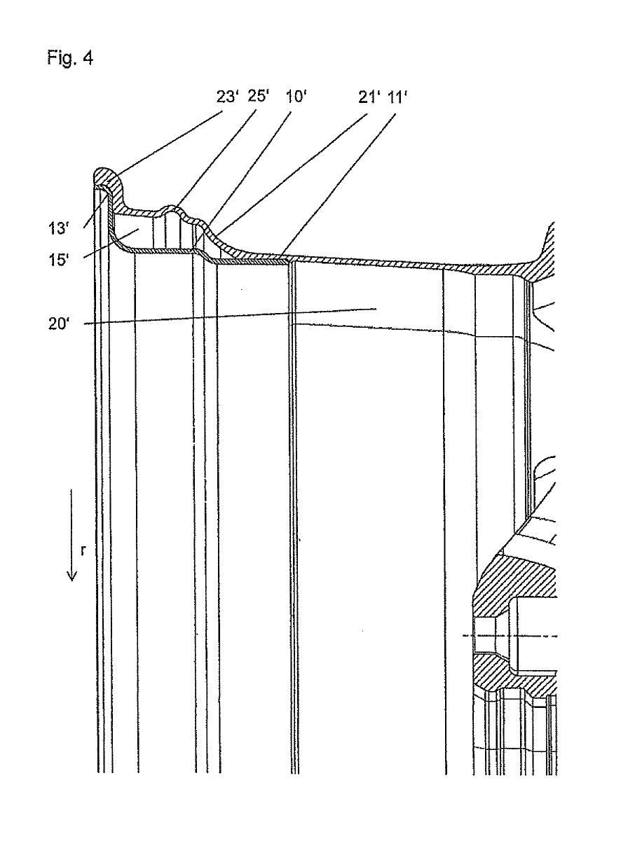

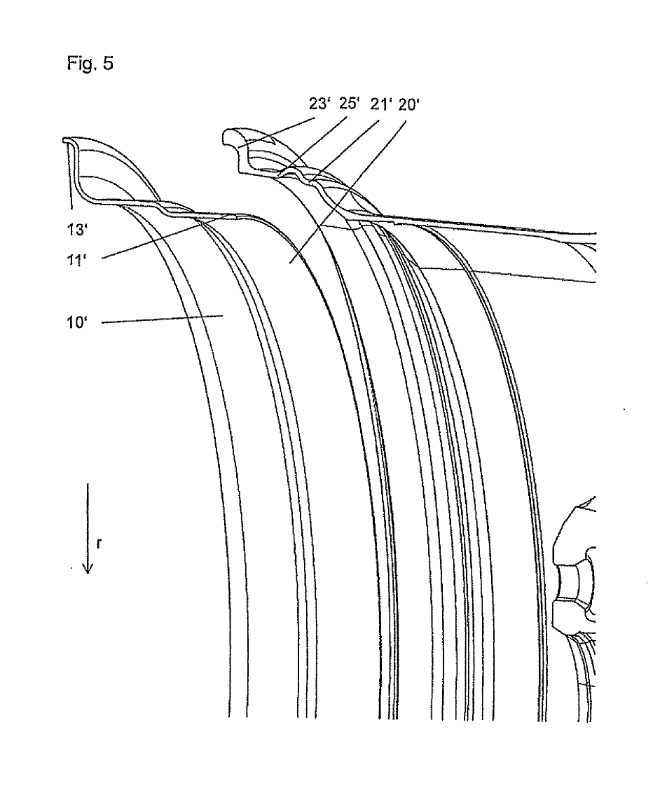

FIG. 3 an exploded, partial perspective view of a radially cross-cut wheel according to the invention and a ring according to the invention, aligned axially thereto, also as an enlarged section.

FIG. 4 an enlarged section, similar to that of FIG. 2, of another alternative cross-section of a wheel according to the invention having a ring according to a second embodiment example of the invention.

FIG. 5. an exploded, partial perspective view of a radially cross-cut wheel according to the invention and a ring according to the second embodiment of the invention of FIG. 4, aligned axially thereto, also as an enlarged section.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

A wheel rim 20 of a wheel according to a first embodiment example of the invention illustrated in FIGS. 1 to 3 is used particularly in an alloy wheel for motor vehicles. The wheel rim 20 has a rim inner well 21 and a rim outer well 22. The rim inner well 21 merges into a rim inner flange 23 which, when the wheel is mounted on a motor vehicle, is disposed facing the motor vehicle (not shown here). The rim outer well 22 merges into a rim outer flange 24. The wheel rim 20 therefore has an uninterrupted contoured section 25 on the axially inner side.

A ring 10 according to the invention is inserted into the contoured section 25. Thus the ring 10 is disposed opposite a customarily integrated wheel spider 26.

The ring 10 has a well lip 11, which extends up to the rim inner well 21 or is designed such that it partially overlaps the rim inner well 21. The ring 10 further has a flange lip 13, which faces away from the well lip 11 and is modeled on the shape of the inner radial surface of the rim inner flange 23. Between the well lip 11 and the flange lip 13, in a hollow chamber region 15, the ring is embodied as at least partially double-walled.

According to said embodiment example, in the hollow chamber region 15, an inner wall 16 extends on the radially inner side and an outer wall 17 extends on the radially outer side, said two walls extending substantially parallel to one another. The more angled the uninterrupted contoured section 25 is, the more angled the outer wall 17 is, and the less parallel and/or axially the outer wall extends. Between the outer wall 17 and the inner wall 16, radial walls 19 are arranged aligned in the radial direction r. Points of connection between walls 16, 17 and 19 are designed as rounded. Statically, the radial walls 19 play a significant role. The outer wall 17 may optionally be dispensed with.

Inside walls 16, 17 and 19, a hollow chamber 18 having a substantially rectangular cross-section is formed, more precisely, a trapezoid, depending upon the pitch of the uninterrupted contoured section 25. A complete closure of the cross-section by means of the outer wall 17 can also be achieved by welding the radial walls 19 directly to the wheel rim 20.

The ring 10 is therefore a hollow profiled section that is optimized in terms of its weight. To accomplish this, according to the embodiment example, closed hollow chambers and/or a single uninterrupted closed hollow chamber 12 are formed, which can be filled with a fluid medium. To achieve noise reduction, the hollow chamber 12 can advantageously be filled with an insulating material.

In the embodiment example, the ring 10 is made of aluminum. Alternative embodiments made of plastic or of combinations of plastic and metal are also possible.

According to the present embodiment example, the ring 10 is glued into the wheel rim 20. For this purpose, an adhesive gap is defined between two sets of corresponding bonding surfaces—well lip 11 with rim inner well 21 and flange lip 13 with rim inner flange 23. An adhesive system can thus be used which hardens during a coating process.

An additional hollow chamber region 28 is formed between the corresponding bonding surfaces. This allows a deformation of the wheel rim to occur without this impacting a corresponding surface of the ring 10. This improves the sturdiness of the adhesive connection.

FIGS. 4 and 5 illustrate a wheel according to a second embodiment example of the invention. Similarly to the first embodiment example, in this case the wheel consists of a wheel rim 20′, into which a ring 10′ is inserted (FIG. 4) or can be inserted (FIG. 5) axially from the outside. According to the invention, the flange lip 13′ and the well lip 11′ of the ring 10′ are likewise nestled into the contoured section 25′, which has been formed in a production step preceding the insertion.

In contrast to the first embodiment example, the ring 10′ and the wheel rim 20′ together form a hollow chamber in the hollow chamber region 15′. In the hollow chamber region 15′, the ring 10′ is embodied as spaced radially from wheel rim 20′.

### LIST OF REFERENCE SIGNS

10, 10′ ring

11, 11′ well lip

12 hollow chamber

13, 13′ flange lip

15, 15′ hollow chamber region

16 inner wall

17 outer wall

18 hollow chamber

20, 20′ wheel rim

21, 21′ rim inner well

22 rim outer well

23, 23′ rim inner flange

24 rim outer flange

25, 25′ uninterrupted contoured section

26, 26′ wheel spider

28 additional hollow chamber region

r radial direction

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A ring for a wheel rim of a wheel, particularly for a wheel rim of an alloy wheel for motor vehicles, wherein the wheel rim has a rim inner well which merges into a rim inner flange which, when the wheel is mounted, is disposed facing an external motor vehicle, and a rim outer well which merges into a rim outer flange, so that the wheel rim has a circumferential contoured section on the axially inner side, wherein:
the ring has a well lip which extends up to the rim inner well or partially overlaps the rim inner well;
the ring has a flange lip which faces away from the lip and is has a shape corresponding to the shape of the inner radial surface of the rim inner flange;
said ring defining a hollow chamber region arranged between the well lip and the flange lip; and
the ring being at least partially double-walled and spaced radially partially from the wheel rim.

2. The ring, according to claim 1, wherein:
the defined hollow chamber region is proximate an inner wall extending on the radially inner side and an outer wall and extends on the radially outer side;
the inner wall and the outer wall extending substantially parallel; and
at least radial walls are aligned in the radial direction and arranged between the outer wall and the inner wall, so that a hollow chamber is formed having a substantially rectangular cross-section.

3. The ring, according to claim 1, wherein:
the ring is at least partially formed as a hollow profiled section having at least one completely closed hollow chamber.

4. The ring, according to claim 3, wherein:
the hollow chamber is filled with an insulating material, particularly with a metal foam or a plastic foam.

5. The ring, according to claim 1, wherein:
The ring is constructed at least partially of one of aluminum and plastic.

6. A wheel, particularly an alloy wheel for motor vehicles, comprising:
a wheel spider and a wheel rim;
the wheel rim having a rim inner well which merges into a rim inner flange on the inner side of the wheel and a rim outer well which merges into a rim outer flange on the outer side of the wheel, so that the wheel rim has a circumferential contoured section on the axially inner side; and
the ring is arranged on the inner side of the wheel.

7. The wheel, according to claim 6, wherein:
the ring is secured by one of a gluing and a welding into the wheel rim, and rests at least partially in the circumferential contoured section.

8. The wheel, according to claim 6, wherein:
a plurality of sole corresponding bonding surfaces are provided between the well lip and the rim inner well and between the flange lip and the rim inner flange, and the ring and the wheel rim are connected to one another solely via the sole corresponding bonding surfaces; and
wherein in a case of a double-walled embodiment of the ring, an additional hollow chamber region is formed radially outside of the hollow chamber region.

9. A wheel system, in particular an alloy wheel for motor vehicles, consisting substantially of a wheel spider and a wheel rim, wherein the wheel rim has a rim inner well which merges into a rim inner flange on an inner side of the wheel and a rim outer well which merges into a rim outer flange on an outer side of the wheel, wherein in one of a region of the inner side of the wheel and an outer side of the wheel, a hollow chamber is formed, extending at least partially continuously in the peripheral direction, and delimited in the region of one of the rim inner well and the rim outer well by a profiled wall, characterized in that the hollow chamber is formed in a separate ring, which is attachable to the wheel.
